(19) United States
(12) Patent Application Publication
(10) Pub. No.: US 2024/0405426 A1
(43) Pub. Date: Dec. 5, 2024

(54) RADIAL PLATE REFLECTOR ARRAY ANTENNA

(71) Applicant: Intersoft Electronics, Olen (BE)

(72) Inventor: Marcel Vanuytven, Geel (BE)

(73) Assignee: Intersoft Electronics, Olen (BE)

(21) Appl. No.: 18/677,945

(22) Filed: May 30, 2024

Related U.S. Application Data
(60) Provisional application No. 63/505,092, filed on May 31, 2023.

(30) Foreign Application Priority Data
May 31, 2023 (LU) LU504381

(51) Int. Cl. H01Q 3/36; H01Q 15/14

(52) U.S. Cl. CPC H01Q 3/36; H01Q 15/141

(57) ABSTRACT

Antenna comprising a plurality of radial antenna elements, each comprising two or more radial conductive guide plates, each of the two or more radial conductive guide plates having a curved edge, a front edge and a bottom edge; wherein each radial antenna element and each radial guide plate lies on a radius of said outer circle, a first conductive sheet material which is mechanically and in a shape-locked way fixed onto, and optionally electronically, connected to a plurality of the curved edges of the plurality of radial antenna elements to form a conductive curved reflector, further comprising: one or more antenna feeds, the one or more antenna feeds being offset from the conductive curved reflector, each radial conductive guide plate being shared between a neighbouring antenna element on one side and a further neighbouring antenna element on the other side of the radial conductive guide plate.

### CROSS-REFERENCE

This application claims the benefit of U.S. provisional application 63/505,092, filed May 31, 2023, and Luxembourg application LU504381, filed May 31, 2023, both of which are incorporated by reference.

### FIELD OF THE INVENTION

The present invention relates to an antenna as well as to a construction method therefor and a method of operation of the antenna as a phased array. The present invention also relates to antenna elements and antenna cassettes.

### BACKGROUND

Many existing radar antennas have mechanically moving parts such as a mechanical drive system including gears and bearings for rotating the antenna dish around the azimuth and elevation axes. The antenna dish is typically parabolic in shape and can have weight of tens or hundreds of kilograms. The drive systems for such antennas need to be precise and highly efficient, thereby facilitating an extremely high margin of accuracy of the observed data. However, a significant drawback is the high initial investment and a subsequent high maintenance cost.

Other systems have been developed using planar electronic phased arrays (i.e., X*Y electronic matrices), with individual control elements operated as a phased array. The cost of such antennas is very high, for example 4 to 10 times higher than mechanically rotating antennas, due to the very large number of control elements required to gain the required accuracy. Usually, the vertical pointing is more or less fixed or such an antenna can work with a limited number of shaped beams exiting the antenna. In existing systems, this is handled by a very large number of individual antenna elements, e.g. dipoles or patch antennas, arranged in rows and columns which are combined by a multitude of complex RF network wirings to create the desired vertical patterns for a multitude of beams.

For traditional rotating antennas, a large parabolic reflector is shaped to obtain vertical beams and illumination by feedhorn antennas. The use of a semi-parabolic reflector for phased array application has never matured and phased arrays are used, generally only for planar radar array antennas that still require rotation to cover all azimuth angles.

In the prior art, reflector designs, such as illustrated in U.S. Pat. No. 4,051,476, the wave of electromagnetic energy leaving a reflector is fed to a parallel plate arrangement to guide the energy provided by a feed connection to the reflector. Some problems occur when matching the reflected wave with the air-interface transition. This limits the use to a single beam as is the case for airborne reconnaissance. The beam scanning is limited and has to be combined with movements of the aircraft along the aircraft flight path or combined with another form of mechanical movement to point the antenna in the desired direction. Mechanical pointing limits the antenna size and requires a lot of reinforcement to maintain the desired mechanical accuracy. The parallel plate setup as depicted in FIG. 7 of U.S. Pat. No. 4,051,476 can only be used for flat linear arrays. In some cases, four such antennas are combined in a square to cover all azimuth directions, but this requires electronic beam squinting of +/−45 degrees and such high squint angles suffer from gain loss and beam widening. In a phased array, the power from a transmitter is fed to parallel radiating antenna elements through devices called phase shifters.

U.S. Pat. No. 4,051,476 discloses tilting the air-interface so that the reflection from the air interface (radiating edge-free space boundary) is returned to a separate connection and absorbed. This avoids the detrimental effects of the reflection on VSWR but fails to avoid the loss in power caused by the absorption.

Known antennas further suffer from transportation and maintenance problems, as they are built in one block of high dimension, are usually heavy and accuracy of their shape is detrimental to their overall accuracy. It is then very difficult to identify and replace a failing element within such antennas, leading to long shutdown periods for maintenance or repair.

### SUMMARY OF THE INVENTION

### System Comprising an Antenna

### Antenna

Embodiments of the present invention provide an antenna having a substantially annular or ring-shaped or sector-shaped or optionally toroid-shaped body form, a flat base and inner and outer circular concentric boundaries. The antenna can optionally be stationary in operation, e.g. non-rotating. The antenna may have at least one cassette which comprises an array of radially placed antenna elements which are stacked together in a ring or part of a ring, i.e. a sector of a ring. Each antenna element comprises at least two spaced apart (forming a radiating antenna slot) non-parallel but rather radial conductive guide plates and a reflector (radial reflector plate) to focus radio frequency energy in the form of an RF signal, e.g. RF beams focussed at one or more elevations. Each radial conductive guide plate can be shared by adjacent antenna elements. The antenna includes a front plate configured as a filter which is used to match an air-interface to the antenna elements and the transition to the antenna for the RF signal incident on the filter, the RF signal having a wavelength.

The radially placed antenna elements of the antenna can be driven electronically as a phased array.

In embodiments of the present invention, the antenna can be a sector-antenna or a full 360°-antenna or circle-antenna. The antenna can optionally be substantially annular or ring-shaped or sector-shaped or toroid-shaped. The antenna can optionally be stationary in operation, e.g. non-rotating.

Embodiments of the present invention provide an antenna that is bounded by an outer circle forming an outer boundary having a diameter D1 and bounded by an inner circle forming an inner boundary having a diameter D2. There is a hole at diameters below D2. The inner circle is concentric with the outer circle, wherein the antenna comprises:
a plurality of radial antenna elements, each radial antenna element comprising two or more radial conductive guide plates, each of the two or more radial conductive guide plates having a curved edge, a front edge and a bottom edge; wherein each radial antenna element and each radial guide plate lies on a radius of the outer circle with diameter D1, wherein:
a first conductive material is mechanically fixed to, and optionally electronically connected to, a plurality of the curved edges of a plurality of radial antenna elements to form a conductive curved reflector, further comprising:
one or more antenna feeds, the one or more antenna feeds being offset from the conductive curved reflector,

each radial conductive guide plate being shared between a neighbouring antenna element on one side of the radial conductive guide plate and a further neighbouring antenna element on the other side of the radial conductive guide plate.

The ratio of D2/D1 is preferably in the range of 0.8 to 0.3 depending on the desired range and height coverage. For example, for air traffic control, a typical range could be 0.7 to 0.5.

The advantages of this antenna include: simple construction, combines a plurality of plates whose shape can be cut out by standard workshop tools, easy to assemble and to repair in-place, low weight, easily transportable, no moving parts, can be configured as a phased array, can be located on a mast.

The antenna of the present invention can have a substantially annular or ring-shaped or sector-shaped or toroid-shaped body, at least in part, meaning that it can be a ring-shaped element with a hole in the middle. It has a surface of revolution with an axis of revolution passing through the hole without intersecting the surface of the antenna. The advantages of this ring-shaped antenna include:

It can send and receive RF beams at different azimuth and elevation directions without moving a large parabolic dish.

The antenna optionally has a second conductive sheet material that is mechanically, optionally in a shape-locked way, fixed to, and optionally electronically connected to, a plurality of front edges of a plurality of radial conductive guide plates to form a front plate. The front plate can be configured as a filter to match an air-interface transition to the antenna.

The front plate preferably comprises resonant slots forming a resonant front filter plate. This has the advantage that energy usage is reduced.

The antenna optionally has a third conductive sheet material that is mechanically fixed to, and optionally electronically connected to, a plurality of bottom edges of a plurality of radial conductive guide plates to form a bottom plate. The bottom plate provides a good location for electronics, e.g. control electronics.

Any, some or all of the first to third conductive sheet materials (or plates) can be made from metal sheet material such as aluminium or of any conductive synthetic material, as an example having a thickness between 0.5 and 1 mm or thicker, such as 1 to 5 mm or 1 to 10 mm.

In embodiments of the present invention, each conductive sheet material (or plates: reflector plate, front plate, bottom plate) has faces, and two or more radial conductive guide plates have a plurality of edges, one or more of the plurality of edges having a means for mechanical connection, and optionally for electronic connection, to the faces. The mechanical connection can be in a shape-locked way.

The means for mechanical connection, optionally in a shape-locked way, and optionally for electronic connection, comprises pin structures on one or more of the plurality of edges of the guide plates in the form of pins, arrowheads or lips and pin receiving structures in the form of pinholes or slots in the faces. The pin structures are inserted into the pinholes or slots in the faces, the pins being bent over in a shape-locked way to lock the pins into the pinholes, the arrowheads being bent over or twisted to shape-lock the arrowheads into the slots or pinholes or the lips being bent over to shape-lock the lips into the slots or pinholes.

Two or more antenna elements of the antenna according to embodiments of the present invention are preferably put together to form an antenna cassette. Three antenna elements in an antenna cassette could be used. Such a cassette could be used for some cases to maintain a limited weight per cassette, e.g. for large antennas. Four antenna elements per cassette could be used. Such a cassette could be used for ATC applications. Higher number of antenna elements in a cassette could be used for antennas operating on frequencies above the S-band. The number of cassettes in an antenna is also selectable. The antenna may comprise 16 to 128, preferably 32 to 64, cassettes. For example, the most used radar for ATC, which is S-band airport approach (ASR), needs 64 cassettes each containing 4 radiating antenna slots or 32 cassettes each containing 8 radiating antenna slots. The second most ATC is for long range enroute detection, L-band, and is likely optimal with 64 cassettes containing 4 radiating antenna slots or 32 cassettes containing 4 radiating antenna slots.

Using cassettes allows installation, maintenance and repair in an efficient and safe manner. A cassette forms a module of a modular system and can be inserted or removed from the antenna. Each cassette can be made of conductive sheet material and can comprise a base plate, a front plate and a curved reflector plate. The antenna has substantially annular or ring-shaped or optionally toroidally shaped body which is formed by mounting a plurality of conductive cassettes one adjacent to the next one around in a circle or in a sector of a circle. The cassettes are removable from the antenna. The use of removable cassettes allows easy and timesaving replacement or repair or construction. The use of cassettes provides the flexibility to adapt to the required antenna technical specification. It provides the possibility to easily re-arrange an antenna in a time-efficient way compared to existing antenna structures which would require a time-consuming complete re-design.

A patch antenna feed array is preferably located at a bottom front inside of each cassette, the patch antenna feed array emitting an RF signal reflected by the conductive curved reflector. The advantage is that the antenna feed array is offset from the reflector, thus avoiding the array blocking the RF beam.

Optionally, two patch antenna feed arrays can be located at a bottom front inside of each cassette, the two patch antenna feed arrays emitting an RF signal reflected by the conductive curved reflector towards a front plate providing beams at at least two elevations. The patch antenna feed array or arrays is/are offset with respect to the curved reflector having the advantage that the arrays do not block the RF signal.

The RF signal has a wavelength and a spacing between the resonant slots of the front plate is less than half of the wavelength of the RF signal. The resonant slots can be configured by changing their length, their position or shape (for example, an X shaped resonant slot can provide wider bandwidth) on the front plate, and as a function of frequency and allow for small band filtering to get rid of out-of-band frequencies.

Transmit Receive Module electronics are preferably located at the bottom back inside each cassette.

The Transmit Receive Module electronics are preferably joined to the patch antenna feed array with low-loss transmission lines.

The patch antenna feed array emits the RF signal that is reflected by the conductive curved reflector and creates, for example a COSEC2 beam pattern.

The antenna can comprise a switching matrix configured to control two or more user applications accessing the same antenna.

The antenna can be a sector or full 360° antenna.

The antenna which comprises n radial antenna elements arranged around a circle can be in the form of a regular n-gon.

The antenna can be operated by a method comprising the step of: operating a plurality of radial antenna elements of the antenna as a phased array or an electronically scanned array. A beam of radio frequency waves is electronically steered by the antenna to point in different directions without moving the antenna. Radio frequency current from a transmitter is fed to the multiple individual antenna elements with a phase relationship so that the radio waves from the separate antenna elements are configured to combine to form beams, to increase power radiated in desired directions and suppress radiation in undesired directions.

The antenna is operated as or used as a phased array, the power from a transmitter being fed to radiate through the front antenna elements via phase shifters, which are controlled by a controller and which can alter the phase or signal delay electronically, thus steering the beam of radio waves to different directions, e.g. one, two or more elevations. The antenna can be scanning in azimuth by feeding the relevant RF power into Transmit/Receive (T/R) modules.

The antenna can be constructed in accordance with a method as explained further in the description, and function as a phased array.

The present invention also relates to an antenna element comprising two or more radial conductive guide plates, each of the two or more radial conductive guide plates having a curved edge, a front edge and a bottom edge.

The present invention further relates to an antenna cassette comprising one or more of such radial antenna elements, whereby the cassette has two or more conductive radial guide plates, a reflector plate, a bottom plate and optionally a front plate. The two or more radial guide plates of the antenna cassette have a plurality of edges, one or more of the plurality of edges having a means for mechanical connection, optionally in a shape-locked way, and optionally for electronic connection, to the faces.

The means for mechanical connection comprises pin structures on one or more of the plurality of edges of the guide plates in the form of pins, arrowheads or lips which are inserted into pin receiving structures such as slots or pinholes in the faces, the pins being bent over to be fixed in a shape-locked way into the pinholes, the arrowheads being bent over or twisted to shape-lock the arrowheads into the slots or pinholes or the lips being bent over to shape-lock the lips into the slots or pinholes.

A patch antenna feed array, which can for example be located at a bottom front inside of the cassette, is configured to emit an RF signal reflected by the reflector plate. The antenna cassette can comprise two patch antenna feed arrays located at a bottom front inside of the cassette, whereby the two patch antenna feed arrays are configured to emit an RF signal reflected by the reflector plate towards the front plate providing beams at at least two elevations.

### Construction Method

A construction method according to the present invention includes the subtractive machining of conductive sheet material using conventional machining methods such as stamping, cutting, grinding, milling, laser ablation and drilling.

The antenna can optionally have a substantially annular or ring-shaped or sector-shaped or optionally toroidal body. The antenna can optionally be stationary in operation, e.g. non-rotating. An antenna according to embodiments of the present invention relates to a construction method therefor and an operation of the antenna as a phased array. The antenna according to embodiments of the present invention allows a simple construction for a sector-shaped antenna or full circle, i.e. circular, antenna. This allows easy and timesaving replacement of existing rotating parabolic or planar phased array antennas as used, for example, in air-traffic control radar systems, as well as of more compact antenna installations. The antenna and the method of construction as well as the method of operation of the antenna as a phased array according to the present invention are also advantageous for supporting high-speed mobile data communication because of its agile electronic beam pointing. These also allow various applications, such as, but not limited thereto, radar (especially airtraffic control) to drone detection, e.g in the range from 0.5 to 10 Ghz as well as mobile communication, e.g. extending to 10 to 100 Ghz, 50 Ghz.

Embodiments of the present invention provide a method of constructing an antenna from a plurality of plates. Each plate can be made of a conductive sheet material, such as metal, for example aluminium, or of any conductive synthetic material. Each plate has two parallel faces and at least one edge. The at least one edge of one plate comprises a connection means for mechanical, and optionally for electronic, connection to one of the two faces of at least one of the other plates. The connection means for mechanical, and optionally for electronic, connection for any, some or all plates is shape-locked. The connection means for mechanical, and optionally for electronic, connection comprises pins on the at least one edge of the one plate which are inserted into pinholes located in at least one of the two faces of at least one of the other plates. The pins are subsequently bent over to lock the pins in the pinholes. Alternatively, the connection means for mechanical, and optionally for electronic, connection comprises on the at least one edge of the one plate arrowheads which are inserted into pinholes or slots located in at least one of the two faces of at least one of the other plates. The arrowheads are subsequently bent over or twisted to lock the arrowheads in the pinholes or slots. Alternatively, instead of pins or arrowheads, the connection means for mechanical, and optionally for electronic, connection comprises lips (e.g. rectangular, square or other shape) shape-locked in pinholes or slots. The shaped-locked connection means for mechanical, and optionally for electronic, connection are preferably distributed evenly on at least one edge or face of the plates.

The plurality of plates is selected from radial guide plates, front plates, bottom plates and reflector plates.

The antenna has a flat base and inner and outer circular concentric boundaries. The antenna comprises an array of radially placed antenna elements forming together a ring or part of a ring, i.e. a sector of a ring. Each antenna element comprises at least two spaced apart non-parallel but rather radial conductive guide plates and a reflector plate. The reflector plate is configured to focus radio frequency energy in the form of an RF signal, e.g. RF beams, focussed at one or more elevations. Each radial conductive guide plate can optionally be shared by adjacent antenna elements. Each antenna element includes a front plate configured as a resonant slot filter which is used to match an air-interface to the antenna elements and the transition to the antenna for the RF signal incident on the filter, the RF signal having a wavelength. The antenna is bounded by an outer circle forming an outer boundary having a diameter D1 and bounded by an inner circle forming an inner boundary which at the bottom of the antenna has a diameter D2 The inner circle is concentric with the outer circle.

Each radial antenna element is made with two or more radial conductive guide plates, each of the two or more radial conductive guide plates having a curved edge, a front edge and a bottom edge.

A first conductive sheet material, which will form the reflector plate of the antenna element, is fixed mechanically and, optionally in a shape-locked way, to, and optionally electronically connected to, the curved edge of the two or more radial antenna elements to form a conductive curved reflector plate.

One or more antenna feeds can be offset from the conductive curved reflector plate.

Thereafter, a second conductive sheet material is mechanically, optionally in a shape-locked way, fixed to, and optionally electronically connected to, the front edge of the two or more radial conductive guide plates to form a front plate of the antenna element.

Neighbouring antenna elements are located on one side of the radial conductive guide plate and a further neighbouring antenna element on the other side of the radial conductive guide plate.

The front plate is configured as a filter to match an air-interface transition to the antenna.

The front plate comprises resonant slots and is configured to operate these slots as a resonant front filter plate.

Furthermore, a third conductive sheet material is fixed mechanically in a shape-locked way to, and optionally electronically connected to, the bottom edge of the two or more radial conductive guide plates to form a bottom plate.

It is clear that the sequence of steps of fixing the first, second and third sheet material to the two or more radial conductive guide plates may be carried out in any order. For example, the second sheet material could be fixed first, followed by the fixing of the first or third sheet material.

The step of mechanically fixing the respective edges of the radial guide plate in a shape-locked way to the front plate and/or the bottom plate and/or the reflector plate can be as follows.

The at least one edge of the radial guide plate comprises a connection means for mechanical, and optionally for electronic, connection to at least one of the other plates, i.e. the reflector plate, the front plate and the bottom plate. The connection means for mechanical, and optionally for electronic, connection comprises pins on the at least one edge of the radial guide plate which are inserted into pinholes located in at least one of the other plates, i.e. the reflector plate, the front plate and the bottom plate. The pins are subsequently bent over to lock the pins in the pinholes. Alternatively, the connection means for mechanical, and optionally for electronic, connection comprises on the at least one edge of the radial guide plate arrowheads which are inserted into pinholes or slots located in at least one of the other plates, i.e. the reflector plate, the front plate and the bottom plate. The arrowheads are subsequently bent over or twisted to lock the arrowheads in the pinholes or slots.

Alternatively, the connection means for mechanical, and optionally for electronic, connection comprises lips (e.g. rectangular, square or other shape) on the at least one edge of the radial guide plate, which lips are inserted into slots located in at least one of the other plates, i.e. the reflector plate, the front plate and the bottom plate. The lips are subsequently bent over or twisted to lock the lips in the slots.

A further alternative included in the present invention is to insert the pins of the respective edges of the radial guide plate in the pinholes of the front plate and/or the bottom plate and/or the reflector plate and to subsequently bend the pins to lock them in the pinholes. The same reasoning applies when arrowheads are used or when lips are used.

Each radial antenna element is placed with its bottom plate on a radius of the outer circle with diameter D1, so that the curved reflector plate is positioned inwardly and the front plate is positioned outwardly. This way reflector plate is facing the inner circle and front plate is facing the outer circle.

The method can also include a step of placing a plurality (i.e. two or more) of radial antenna elements together in a cassette. A cassette is two or more radial antenna elements in a module, which module can be inserted or removed from the antenna, e.g. for repair or replacement or construction on site. The cassettes are removable from the antenna. The use of removable cassettes allows easy and timesaving replacement or repair or construction. Optionally, in each cassette, each conductive radial guide plate or several or most of the conductive radial guide plates can be shared by two neighbouring antenna elements. Hence, in instead of two radial guide plates per antenna element, there is only one. This arrangement reduces the weight by a factor of about 2. In case a cassette contains more than two antenna elements, at least one radial guide plate can be shared by neighbouring antenna elements. This also results in a reduction of the weight.

Additionally, the method places an antenna feed, comprising for example a patch antenna feed array at a bottom front inside of each cassette, i.e. on the bottom plate and adjacent the front plate. The patch antenna feed array is configured for emitting an RF signal to the conductive curved reflector plate which is configured to reflect the signal, so that the signal will exit the antenna. Alternatively, the antenna is configured to receive an RF signal which is reflected by the conductive curved reflector plate to the patch antenna feed array.

Additionally or alternatively, the method places an antenna feed, comprising for example two or more patch antenna feed arrays at a bottom front inside of each cassette, i.e. on the bottom plate and adjacent the front plate. The two or more patch antenna feed arrays are configured for emitting RF signals to the curved reflector plate which reflects the signals, so that each exit the antenna at a different elevation angle. Alternatively, the antenna is configured to receive RF signals from different elevation angles which are reflected by the conductive curved reflector plate to the two or more patch antenna feed arrays.

The RF signal has a wavelength and a spacing is set between the resonant slots that is less than half of the wavelength of the RF signal.

The resonant slots are tuned as a function of frequency and allow for small band filtering to get rid of out of band frequencies.

The patch antenna feed arrays are adapted to emit the RF signal which is reflected by the conductive curved reflector, creating a COSEC2 beam pattern.

Transmit Receive Module electronics are located at the bottom back inside each cassette, i.e. on the bottom plate and adjacent the reflector plate.

The Transmit Receive Module electronics are joined to the patch antenna feed array with low-loss transmission lines.

The antenna is configured for use as a phased array.

A switching matrix is configured to control two user applications accessing the same antenna.

The antenna constructed by the methods of the present invention preferably has a ring or annular form with inner and outer multifaceted circular boundaries wherein these inner and outer circular boundaries are concentric with each other. The antenna has a flat base. The antenna has a form approximating a surface of revolution of half-a-parabola-like shape, whereby the antenna has a hole in the middle. The axis of revolution passes through centre of the hole and does not intersect with the multifaceted surfaces of the antenna. This shape is achieved by a plurality of radially placed conductive antenna elements each being a part of a sector of a hemisphere, whereby these antenna elements are placed next to each other around a circle or sector of a circle. When placed together, the antenna elements each comprise two or more spaced apart radial conductive guide plates. The shape of half a parabola corresponds to the shape of a radial guide plate which is part of the antenna element. This shape is the shape of a cross-section taken vertically through the antenna element and, hence, through the antenna.

The radial antenna elements also form reflectors to focus radio frequency energy incident on these reflectors in the form of an RF signal, e.g. one or more RF beams focussed at one or more elevations. Each radial conductive guide plate can be shared by adjacent antenna elements. The antenna includes a front plate configured as a filter which is used to match an air-interface transition to the antenna for the RF signal incident on the filter, the RF signal having a wavelength. The antenna elements contributing to the antenna aperture need to be separated from each other by about ½ of the wavelength of the RF signal or less and not more than 0.8 times this wavelength.

### Phased Array

A particular advantage of an antenna which comprises a plurality of radial antenna elements according to embodiments of the present invention, is that it can be operated as a phased array, e.g. as an electronically scanned array.

To achieve this, a beam of radio frequency waves is provided, which beam can be electronically steered to point in different directions without moving the antenna, in contrast to for example, rotating an antenna dish. Radio frequency current with the proper phase relationship sent from a transmitter is fed to the multiple individual antenna elements so that the radio waves from the individual antenna elements combine to form beams, to increase power radiated in desired directions and suppress radiation in undesired directions.

In a phased array according to embodiments of the present invention, the power from a transmitter can be fed to radiating antenna elements of the antenna through devices called phase shifters. The phase shifters are controlled by the controller and can alter the phase or signal delay electronically, thus steering the beam of radio waves to different directions, e.g. to one, two or more elevations.

Scanning can be done in azimuth by feeding the relevant RF power and RF phase into Transmit/Receive (T/R) modules by means of electrical signals.

The antenna according to embodiments of the present invention allows a simple construction for a sector-shaped antenna or full circle, i.e. circular, antenna. This allows easy and timesaving replacement of existing rotating parabolic or planar phased array antennas as used, for example, in air-traffic control radar systems. The antenna and the method of construction according to the present invention are also advantageous for supporting high-speed mobile data communication also because of the agile electronic beam pointing capability of the antenna.

A antenna according to embodiments of the present invention relates to a construction method therefor and an operation of the antenna as a phased array.

A plurality of Transmit/Receive (T/R) modules can be configured such that each of the cassettes is connected to at least one associated T/R module of said plurality of T/R modules.

A controller can be provided that drives T/R modules such that each of the T/R modules reflects and transmits an RF signal with a predetermined amplitude, frequency and phase. This produces a focussed beam in a desired direction, e.g. in one or more elevations or azimuth directions.

The present invention relates generally to antennas which optionally have a substantially annular or ring-shaped or sector-shaped or optionally toroidal body, and can be pointed by electronic means, i.e. by suitably configured T/R modules. These antennas can be used for phased array applications. This allows provision of an agile electronic pointing rather than relying on mechanical rotation of an antenna as is the case for many of the prior art radar antennas. The antenna is made of radially located conductive antenna elements, in the form of cassettes placed adjacent to each other to form a 360° circle-antenna or a sector of a circle antenna, i.e. sector-antenna. The antenna can optionally be stationary in operation, e.g. non-rotating.

The antenna allows a simple construction of cassettes for a sector or full circle antenna, e.g. to replace rotating parabolic or planar phased array antennas as used for example, in air-traffic control radar systems. The antenna and the method and method of construction are advantageous for supporting high-speed mobile data communication because of its agile electronic beam pointing.

### BRIEF DESCRIPTION OF THE FIGURES

FIG. 1a shows a top view of a complete 360° antenna 1, showing a plurality of radial antenna elements 2. FIG. 1b is a perspective view of the 360° antenna 1 of FIG. 1a.

FIG. 2 shows a plurality of conductive radial guide plates 7.

FIG. 3 shows individual front, bottom and reflector plates which may be supplied for fixing two to five or more conductive radial guide plates 7 together.

FIG. 4 shows a conductive radial guide plate 7 that is shown as a section through an antenna element or through a cassette, with a mechanical fixing means such as pins or arrowheads or lips 8 on the curved edge of the conductive radial guide plate 7.

FIG. 5 illustrates a detail of the front resonant slot filter plate 12 or front plate 12.

FIG. 6 shows a detail of assembling a cassette 20. It shows how a reflector plate and a bottom plate are connected to a conductive radial guide-plate by means of pinhole or slot connections.

FIG. 7 shows a reflector plate comprising five rows of slots in which lips or arrowheads of a radial guide plate have been placed.

FIG. 8a shows a sector-antenna which is a halve-circle antenna and 8b shows another sector-antenna in accordance with an embodiment of the present invention.

FIG. 9 shows a Vertical Polar Diagram (VPD).

### DEFINITIONS

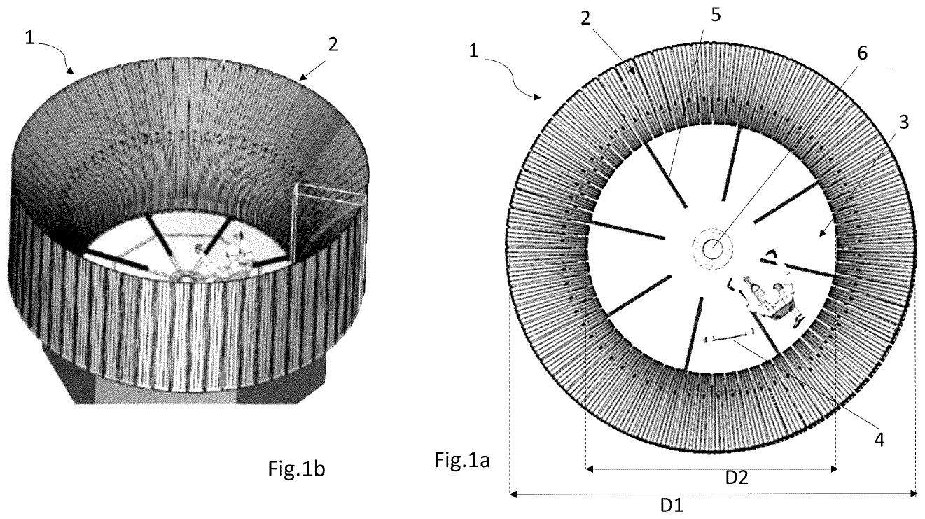

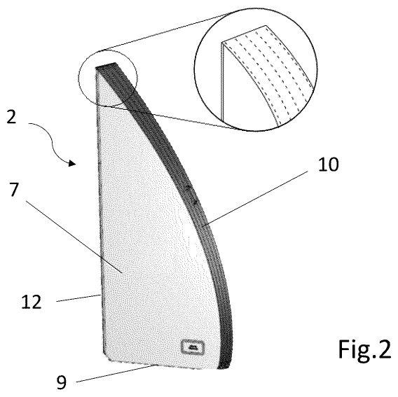

Toroid. A toroid is a surface of revolution with a hole in the middle. The axis of revolution passes through the hole and so it does not intersect the surface. For example, when a shape as shown in FIG. 2, 3 or 4 is rotated around an axis of revolution then the result is a 3D shape similar to that shown in FIGS. 1a and 1b.

Regular n-gon. As shown in FIG. 2, the radial antenna elements 2 have an outer flat sheet. When a number of these radial antenna elements are stacked vertically as shown in FIG. 1a or 1b, the outer surface approaches a circle as the number of radial antenna elements or cassettes gets larger.

A shape which has n sides may be called a regular n-gon. The shape of the inner boundary of the antenna having a smaller diameter D2 is a regular n-gon, where n is the number of radial antenna elements, or cassettes and the shape of the larger diameter D1 is the same regular n-gon concentric with the regular n-gon of the diameter D1.

Shape-locked or form-locked means form closure or locked to be positive-form locked or positive-locked fit.
ATC: Air Traffic Control
BITE: Built In Test Equipment
CAD: Computer Aided Design
COS: Cone of Silence
COTS: Commercial Off The Shelf
LNA: Low Noise Amplifier
PCB: Printed Circuit Board
Radar: Radio Detection and Ranging
Radome: Radio-transparent window used to protect an antenna principally against the effects of weather
RF: Radio Frequency
RPR: Radial Plate Reflector
TRM: Transmit-Receive module
VCC: Vertical Clutter Cancelling
VPD: Vertical Polar Diagram
VSWR: Voltage Standing Wave Ratio

### DETAILED DESCRIPTION

Radial Plate Reflector array antenna

Embodiments of the present invention will be described with reference to FIGS. 1 to 9. The antenna according to embodiments of the present invention can be constructed in modules or even in individual pieces that can be connected on site. Accordingly, embodiments of the present invention are described below in separate modules, such as an antenna element, a cassette.

FIG. 1a shows a top view of an antenna 1. FIG. 1b is a perspective view of antenna 1 of FIG. 1a. Antenna 1 can be a sector antenna or a full-circle (360°) antenna. Antenna 1 is optionally stationary in operation in contrast to, for example, parabolic antennas.

Embodiments of the present invention provide an antenna 1 comprising a plurality of plates 7, 9, 10, 12. Each plate 7, 9, 10, 12 can be made of a conductive sheet material, such as metal, for example aluminium, or of any conductive synthetic material. Each plate 7, 9, 10, 12 has two parallel faces and at least one edge and has a thickness of 0.5 and 1 mm or thicker, such as 1 to 5 mm or 1 to 10 mm.

The at least one edge of one plate 7 comprises a connection means 8, 11 for mechanical, and optionally for electronic, connection to one of the two faces of at least one of the other plates 9, 10, 12. The connection means 8, 11 for mechanical, and optionally for electronic, connection for any, some or all plates is shape-locked. The shape-locked connection means 8, 11 for mechanical, and optionally for electronic, connection can comprise pins 8 on the at least one edge of the one plate 7 which are shape-locked in pinholes 11 located in at least one of the two faces of at least one of the other plates 9, 10, 12. The pins are bent over thus locking the pins 8 in the pinholes 11. Alternatively, the connection means 8, 11 for mechanical, and optionally for electronic, connection comprises on the at least one edge of the one plate 7 arrowheads 8 which are shape-locked in pinholes 11 or slots 11 located in at least one of the two faces of at least one of the other plates 9, 10, 12. The arrowheads 8 are bent over or twisted thus locking the arrowheads in the pinholes or slots. Alternatively, instead of pins or arrowheads, the connection means 8, 11 for mechanical, and optionally for electronic, connection comprises lips (e.g. rectangular, square or other shape) shape-locked in pinholes 11 or slots 11. The shaped-locked connection means 8, 11 for mechanical, and optionally for electronic, connection are preferably distributed evenly on at least one edge or face of the plates 7, 9, 10, 12. The plurality of plates 7, 9, 10, 12 comprises radial guide plates 7, front plates 12, bottom plates 9 and reflector plates 10.

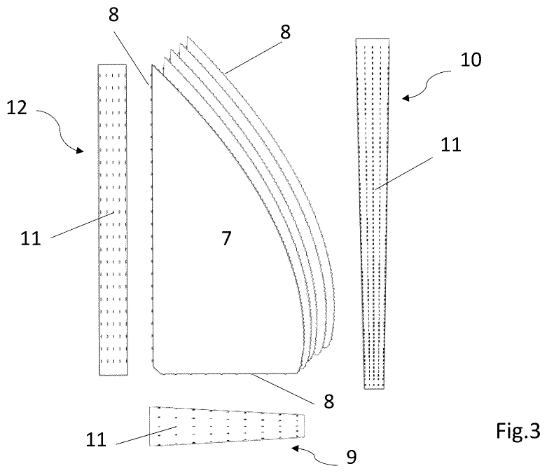

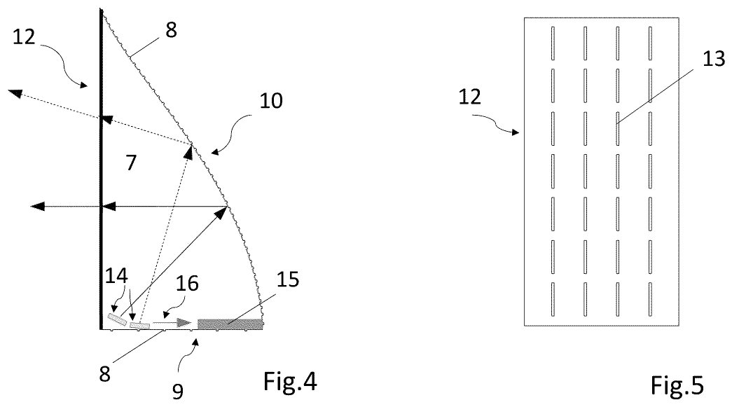

Antenna 1 preferably has a flat base and inner and outer circular concentric boundaries. Antenna 1 comprises an array of radially placed antenna elements 2 forming together a ring or part of a ring, i.e. a sector of a ring. Each antenna element 2 comprises at least two spaced apart non-parallel but rather radial conductive guide plates 7 (shown in FIGS. 3 and 4) and a reflector plate 10. The reflector plate 10 is configured to focus radio frequency energy in the form of an RF signal, e.g. RF beams, focussed at one or more elevations. Each radial conductive guide plate 7 can optionally be shared by adjacent antenna elements 2. Each antenna element 2 includes a front plate 12 preferably configured as a resonant slot filter which is used to match an air-interface to the antenna elements 2 and the transition to the antenna 1 for the RF signal incident on the filter, the RF signal having a wavelength. Antenna 1 is bounded by an outer circle forming an outer boundary having a diameter D1 and bounded by an inner circle forming an inner boundary which, at the bottom of radial antenna 1, has a diameter D2. Diameter D2 is smaller than diameter D1. The ratio of D2/D1 is preferably in the range of 0.8 to 0.3 depending on the desired range and height coverage. For example, for air traffic control, a typical range could be 0.7 to 0.5.

The inner circle is concentric with the outer circle. The conductive radial guide plates 7 each extend from the outer circle to the inner circle. As D1 is larger than D2, the spacing of radial guide plates 7 diverges from the inner circle to the outer circle, whereas conventional antenna plates are parallel. As the number of radial antenna elements 2 increases, the outer diameter and the inner diameter approach that of a circle.

Each radial antenna element 2 comprises two or more radial non-parallel but rather conductive guide plates 7, each of the two or more radial conductive guide plates 7 having a curved edge, a front edge and a bottom edge.

Each radial antenna element 2 and conductive radial guide plate 7 has a bottom plate 9, a front plate 12 and a reflector plate 10 as shown in FIGS. 1 to 4. Each radial antenna element 2 or radial conductive guide plate 7 lies with its bottom plate 9 on a radius of the outer circle with diameter D1, so that the curved reflector plate 10 is positioned inwardly and the front plate 12 is positioned outwardly. This way reflector plate 10 is facing the inner circle and front plate 12 is facing the outer circle.

The use of conductive radial guide plates 7 located radially with respect to the outer circle means that the conductive radial guide plates 7 are not parallel to each other but diverge as they extend from the inner circle to the outer circle. Each or most of the conductive radial guide plates 7 may be insulated from a neighbouring conductive radial guide plate 7 by a layer of insulation. A dielectric can be used. In a preferred embodiment, no dielectric is used except for air, thus forming a very simple construction. Preferably, air is the insulator between two adjacent conductive radial guide plates 7. However, preferably each or most of the conductive radial guide plates is/are shared between two radial antenna elements 2. This reduces the weight by a factor of about two.

Optionally, as a further improvement, a plurality (i.e. two, three, four up to eight or more) of radial antenna elements 2 are located together in a cassette. The conductive radial antenna elements 2 contain two or more non-parallel but rather radial plates 7. Three antenna elements in an antenna cassette could be used. Such a cassette could be used for some cases to maintain a limited weight per cassette, e.g. for large antennas. Four antenna elements per cassette could be used. Such a cassette could be used for ATC applications. Higher number of antenna elements in a cassette could be used for antennas operating on frequencies above the S-band. A cassette forms a module of a modular system and can be inserted or removed from the antenna 1, e.g. for repair or replacement or construction on site. The cassettes are removable from the antenna. The cassettes are preferably placed against each other or with a very small separation distance, for example smaller than 1/10th of the wavelength of the output RF signal. The use of removable cassettes allows easy and timesaving replacement or repair or construction. It also allows transportation within the dimensional limits of road and rail transport (e.g., height of bridges).

Optionally, in each cassette, each conductive radial guide plate 7 or several or most of the conductive radial guide plates 7 can be shared by two neighbouring antenna elements 2. Neighbouring antenna elements 2 are located on one side of a radial guide plate 7 and a further neighbouring antenna element 2 is located on the other side of the guide plate 7. Hence, in instead of two radial guide plates 7 per antenna element 2, there is only one guide plate 7. This arrangement reduces the weight of the antenna 1 by a factor of about 2. In case a cassette contains more than two antenna elements 2, at least one (or most or each) radial guide plate 7 can be shared by neighbouring antenna elements 2. This also results in a reduction of the weight.

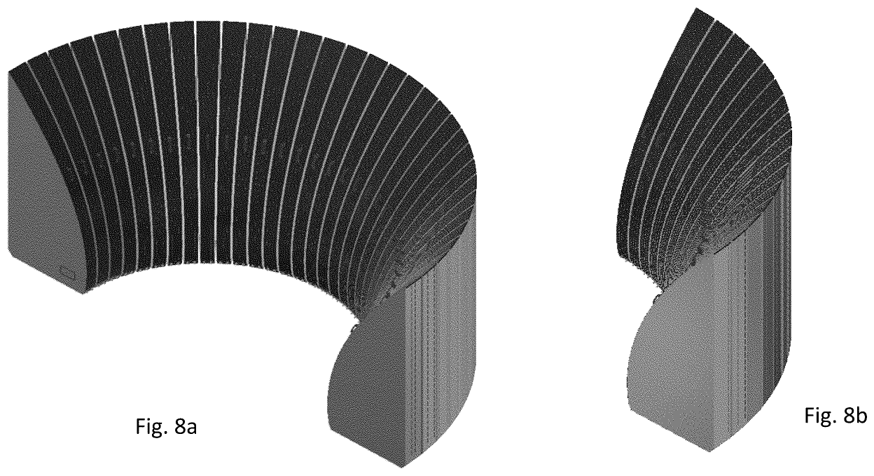

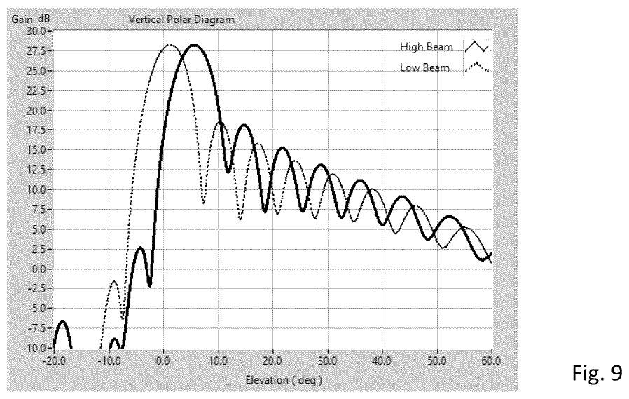

The cassettes can be arranged into a circular array of an antenna 1, covering a sector (of 90° to) 180° of a circle, i.e. forming a sector-antenna, or covering up to 360°, i.e. forming a full-circle antenna which then forms a squintless antenna in frequency. This provides the desired azimuthal pointing while the shape of the reflector plate 10 provides the VPD (Vertical Polar Diagram) as shown in FIG. 9, for two or more beams, depending on the field of application. The antenna 1 may be made with a plurality of sector-antennas. An example of a sector-antenna is shown in FIGS. 8a and 8b.

The modular solution according to embodiments of the present invention allows to form antenna 1 with a flat base, with individual columns of antennas elements 2 placed next to each other and separated by at the most about ½ the wavelength of the RF signal. Only the antenna aperture elements need to be separated by about ½ of the wavelength of the RF signal, preferably not more than 0.8 of the wavelength of the RF signal. The antenna can optionally be stationary in operation, e.g. non-rotating.

Additionally, an antenna feed, comprises for example a patch antenna feed array 14 at a bottom front inside of each cassette, i.e. on the bottom plate 9 and adjacent the front plate 12. The patch antenna feed array 14 is configured for emitting an RF signal to the curved reflector plate 10 which is configured to reflect the signal, so that the signal exits the antenna 1. Alternatively, antenna 1 is configured to receive an RF signal which is reflected by the conductive curved reflector plate 10 to the patch antenna feed array 14. The antenna feed 14 can be offset from the conductive curved reflector plate 10.

Additionally or alternatively, an antenna feed comprises for example two or more patch antenna feed arrays 14 at a bottom front inside of each cassette, i.e. on the bottom plate 9 and adjacent the front plate 12. The two or more patch antenna feed arrays 14 are configured for emitting RF signals to the curved reflector plate 10 which reflects the signals, so that the signals each exit antenna 1 at a different elevation angle. Alternatively, antenna 1 is configured to receive RF signals from different elevation angles which are reflected by the conductive curved reflector plate 10 to the two or more patch antenna feed arrays 14. The two or more patch antenna feed arrays 14 can be offset from the conductive curved reflector plate 10.

The RF signal has a wavelength and a spacing is set between the resonant slots that is less than half of the wavelength of the RF signal.

The resonant slots are tuned as a function of frequency and allow for small band filtering to get rid of out-of-band frequencies.

The patch antenna feed arrays 14 are adapted to emit the RF signal which is reflected by the conductive curved reflector plate 10, creating a COSEC2 beam pattern.

Transmit Receive module (TRM) electronics 15 are located at the bottom back inside each cassette, i.e. on the bottom plate 9 and adjacent the reflector plate 10.

The Transmit Receive module (TRM) electronics 15 are joined to the patch antenna feed array 14 with low-loss transmission lines.

The antenna 1 is configured for use as a phased array.

A switching matrix is configured to control two user applications accessing a same antenna 1.

Antenna 1 preferably has a ring or annular form with inner and outer multifaceted circular boundaries wherein these inner and outer circular boundaries are concentric with each other. The antenna 1 has a flat base. Antenna 1 has a form approximating a surface of revolution of half-a-parabola-like shape, whereby the antenna has a hole in the middle. The axis of revolution passes through centre of the hole and does not intersect with the multifaceted surfaces of the antenna. This shape is achieved by a plurality of the radially placed conductive antenna elements 2 each being a part of a sector of a hemisphere, whereby these antenna elements 2 are placed next to each other around a circle or sector of a circle. When placed together, the antenna elements 2 each comprise two or more spaced apart radial conductive guide plates 7. The shape of half a parabola corresponds to the shape of a radial guide plate 7 which is part of the antenna element 2. This shape is the shape of a cross-section taken vertically through the antenna element 2 and, hence, through the antenna 1.

The radial antenna elements 2 also form reflectors to focus radio frequency energy incident on these reflectors in the form of an RF signal, e.g. one or more RF beams focussed at one or more elevations. Each radial conductive guide plate 7 can be shared by adjacent antenna elements 7. Antenna 1 includes a front plate 12 configured as a filter which is used to match an air-interface transition to the antenna for the RF signal incident on the filter, the RF signal having a wavelength. The antenna elements 2 contributing to the antenna aperture need to be separated from each other by about ½ of the wavelength of the RF signal or less and not more than 0.8 times this wavelength.

With the antenna 1 in accordance with embodiments of the present invention, there is no need for a separate substrate layer nor is there a need to attach the antenna to a base to provide mechanical strength. Avoiding the substrate or a base reduces weight. This also reduces time of installation of the antenna. The antenna 1 is self-supporting or sectors of the antenna 1 are each self-supporting or the cassettes are each self-supporting. To achieve this, the various parts of the antenna are made of sheet material such as a conductive sheet material, such as sheet metal, e.g. sheet aluminium, or synthetic material. whereby the individual plates are preferably joined together mechanically. Welding or gluing can be envisaged, though this would make dismantling difficult and would mean that larger pieces would have to be transported and lifted into position. Instead, simple mechanical fastenings can be used. A very large number of different mechanical fastenings, which can be used with the present invention, are available to the skilled person. In case these mechanical fastenings are on a radiating surface (depending on their design), then these fastenings should be spaced by a distance less than the antenna's RF signal wavelength lamda such as lamda/2 or in the range lamda/4 to lamda.

A manhole 4 can optionally be provided in the antenna floor 3. An optional construction 5 can be provided inside the inner boundary of the antenna or outside the outer boundary for using as an aid for installation. An optional mast-drive-through hole 6 can be provided inside the inner boundary of the antenna to allow for a mast-wrap-around mounting of the antenna 1 according to an embodiment of the present invention. This allows for a symmetric weight distribution around the mast and a light-weight antenna.

### Front, Bottom, Reflector and Guide Plates

FIG. 2 shows a plurality of conductive radial guide plates 7 which can be supplied as separate pieces and are connected to a conductive curved reflector (plate) 10. Alternatively, conductive radial guide plates 7 can be fixed together to form radial antenna elements 2, e.g. in the form of a cassette 20 according to embodiments of the present invention.

FIG. 3 shows individual front, bottom and reflector plates 12, 9 and 10 which may be supplied for fixing two to five or more conductive radial guide plates 7 together. These plates may be transported to site as individual items or in combinations of 2 to 7 of such plates. Any or some or all of the front, bottom and reflector plates can be and preferably are made from a flat sheet of conductive material such as a metal like aluminium or an aluminium alloy.

A mechanical fixing means, and optionally electronic connections, is optionally in the form of slots or pinholes 11 in the reflector plate 10 and in the form of pins or arrowheads or lips 8 on the curved edges of the conductive radial guide plates 7. The pins or arrowheads or lips 8 of the conductive radial guide plates 7 are forced into the pinholes or slots 11 and then, the pins or arrowheads or lips 8 are bent over or twisted to connect the reflector plate 10 in a shape-locked way to the conductive radial guide plates 7.

The bottom plate 9 can also be made of a flat sheet material such as sheet metal, like aluminium or an aluminium alloy. A mechanical fixing means, and optionally electronic connections, is optionally in the form of slots or pinholes 11 in the bottom plate 9 and in the form of pins or arrowheads or lips 8 on the bottom edges of the conductive radial guide plates 7. The pins or arrowheads or lips 8 of the conductive radial guide plates 7 are forced into the pinholes or slots 11 and then, the pins or arrowheads or lips 8 are bent over or twisted to connect the bottom plate 9 in a shape-locked way to the two to five or more conductive radial guide plates 7.

A front plate 12 preferably made from flat sheet material such as a metal like aluminium or an aluminium alloy. A mechanical fixing means, and optionally electronic connections, is optionally in the form of slots or pinholes 11 in the front plate 12 and in the form of pins or arrowheads or lips 8 on the front edges of the two to five or more conductive radial guide plates 7. The pins or arrowheads or lips 8 of the conductive radial guide plates 7 are forced into the pinholes or slots 11 and then, the pins or arrowheads or lips 8 are bent over or twisted to connect the front plate 12 in a shape-locked way to the two to five or more conductive radial guide plates 7. Openings such as holes or slits will be made in front plate 12 to make a resonant filter and will configure the resonant slot filter at the air-antenna interface, to match the RF beam from the reflector guided by the conductive radial guide plates 7 to the air-antenna interface.

One or more antenna feeds can be offset from the conductive curved reflector plate.

Referring particularly to FIGS. 2 to 5, a conductive material, e.g. sheet material of metal such as aluminium or a synthetic conductive material, is mechanically fixed by a mechanical fixing means onto a plurality of the curved edges of a plurality of conductive radial guide plates 7 to form a conductive curved reflector 10. The mechanical fixing means can be provided by pins on the curved edges of the plurality of conductive radial guide plates 7 and pinholes 11 in the curved reflector sheet material 10. The reflector sheet material 10 needs to be tapered due to the different diameters D1 and D2. Most or each of the radial conductive guide plates 7 are shared between a neighbouring antenna element on one side of the radial conductive guide plate 7 and a further neighbouring antenna element on the other side of the radial conductive guide plate.

Optionally, in each cassette 20, each conductive radial guide plate 7 or several or most of the conductive radial guide plates 7 can be shared by two neighbouring antenna elements 2. Hence, in instead of two radial guide plates 7 per antenna element 2, there is only one. This arrangement reduces the weight by a factor of about 2. In case a cassette 20 contains more than two antenna elements 2, at least one radial guide plate 7 can be shared by neighbouring antenna elements. This also results in a reduction of the weight.

A plurality of antenna feeds 14 are provided e.g. in the form of one or more patch antennas, the antenna feeds 14 being offset from the conductive, curved reflector 10. Most or each of the radial conductive guide plates 7 are shared between a neighbouring antenna element 2 on one side of the radial conductive guide plate 7 and a further neighbouring antenna element 2 on the other side of the radial conductive guide plate 7. The conductive shaped reflector plate is an element of a cassette 20.

### Antenna Feed

The antenna 1 comprises a switching matrix configured to control two user applications, which access said same antenna 1 via two or more patch antenna feed arrays. A user application can, for example, be a surveillance scanning, a search function, a use of a dedicated tracking beam. The switching matrix is configured to connect two or more user inputs to the same antenna phased array. For instance, the two or more user inputs can be used to carry out a surveillance scanning. They can also provide a search function simultaneously while a dedicated tracking beam can focus on the few non-cooperative targets. This way, the available transmit power of the antenna 1 is used much more efficiently or allows the use of low power TRM (transmit receive module) electronics. Two or more patch antenna feed arrays 14 are located on the same PCB as the TRM electronics.

One or more patch antenna feed arrays 14 are provided at the bottom of the conductive radial guide plate 7 and adjacent the bottom of the front plate 12. The one or more patch antenna feed arrays 14 are therefore offset from the reflector beam 10 so that RF signals which are emitted from the one or more antenna feeds are reflected off the reflector plate 10, e.g. at different electronically controllable elevations. These one or more patch antenna feed arrays 14 can be in the form of a patch antenna feed array placed at the front and on the bottom plate adjacent to the front plate 12. TRM electronics 15 and a generator of BITE signals 16 can be located on the base plate 9 located between front plate 12 and the reflector plate 10.

Further with respect to patch antenna feed arrays and cassettes, FIG. 4 is referred to. FIG. 4 illustrates the front resonant slot filter plate 12 forming the air interface. Patch antenna feed arrays 14, TRM electronics 15, BITE signal 16 and the reflector contour with pins 8 are shown. Two or more patch antenna feed arrays 14 are located at the bottom front inside of each cassette, creating, for example a COSEC2 beam pattern by reflecting an RF signal from the shaped reflector 10. TRM electronics 15 are located at the bottom and the back inside the cassette 20, i.e. on the bottom plate 9 and adjacent the reflector plate 10. Bringing TRM electronics close to the patch antenna feed arrays 14 allows for low-loss transmission lines and enables an optimal BITE signal 16. Transmit Receive module (TRM) electronics 15 are located at the bottom back inside each cassette 20, i.e. on the bottom plate 9 and adjacent the reflector plate 10.

The Transmit Receive module (TRM) electronics 15 are joined to the patch antenna feed array 14 with low-loss transmission lines.

Additionally, an antenna feed, comprises for example a patch antenna feed array 14 at a bottom front inside of each cassette, i.e. on the bottom plate 9 and adjacent the front plate 12. The patch antenna feed array 14 is configured for emitting an RF signal to the curved reflector plate 10 which is configured to reflect the signal, so that the signal exits the antenna 1. Alternatively, antenna 1 is configured to receive an RF signal which is reflected by the conductive curved reflector plate 10 to the patch antenna feed array 14. The antenna feed 14 can be offset from the conductive curved reflector plate 10.

Additionally or alternatively, an antenna feed comprises for example two or more patch antenna feed arrays 14 at a bottom front inside of each cassette, i.e. on the bottom plate 9 and adjacent the front plate 12. The antenna feeds 14 are offset from the conductive, curved reflector 10. The two or more patch antenna feed arrays 14 are configured for emitting RF signals to the curved reflector plate 10 which reflects the signals, so that the signals each exit antenna 1 at a different elevation angle. Alternatively, antenna 1 is configured to receive RF signals from different elevation angles which are reflected by the conductive curved reflector plate 10 to the two or more patch antenna feed arrays 14. The two or more patch antenna feed arrays 14 can be offset from the conductive curved reflector plate 10.

As shown in FIG. 4, the one or more antenna feeds 14 are preferably placed at the bottom and at the front of a cassette 20. The typical COSEC2 vertical pattern often required for Air traffic control (ATC) still has large oscillations on high elevations causing a loss of target detection and increased COS. This is counteracted in the present invention by using minimum two antenna feeds 14, each of which can be shifted independently by different amounts thereby radiating beams reflected from the reflector of the antenna 1 with two different elevation angles. Combining the two beams, each with different oscillations, allows to reduce the oscillation and unwanted sidelobes to a very low level. This method is described in US2011/0181455A1 which is incorporated herewith in its entirety.

The patch antenna feed array 14 for the antenna 1 is preferably a small feed array of two or more patch antenna feeds 14. An offset-feed architecture is used to avoid aperture blockage and, thus, allowing good control of the elevation far-field pattern. Offset feeding is also well suited for asymmetrically shaped radiating/illumination patterns.

These two or more patch antenna feeds 14 are used to shape the desired reflector illumination pattern of antenna 1. This also allows to electronically tilt the main beam and trace the contours of the local horizon or avoid illumination of sensitive ground areas or, for example, to avoid clutter. Combining patch antenna feeds 14 on a same PCB which has Transmit Receive Module (TRM) electronics 15, can further reduce RF cabling and system cost. Two or more patch antenna feed arrays are located on the same PCB as the TRM electronics 15.

### Air-Antenna Interface

FIG. 5 illustrates a detail of the front resonant slot filter plate 12 or front plate 12. FIG. 5 shows resonant slots (also called filter slots) 13 forming up to three cassettes. The slots 13 are tuned as a function of the RF frequency. They can provide for small band filtering to get rid of out-of-band frequencies. An RF signal arriving at the front plate 12 has a wavelength and a spacing between the resonant slots is preferably less than half of the wavelength of the RF signal.

The RF signal has a wavelength and a spacing between pin structures of the front plate is less than half of the wavelength of the RF signal. The resonant slots can be configured by changing their length, their position or shape (for example, an X shaped resonant slot can provide wider bandwidth) on the front plate, and as a function of frequency and allow for small band filtering to get rid of out-of-band frequencies.

The present invention uses a front filter plate 12, to match the beam guided by the conductive radial guide plates 7 from the reflector plate 10 with the air-antenna interface. This avoids the normal reflection loss while providing a vertical ring shape or sector shape of the antenna 1 that simplifies a radome construction required for weather protection.

The proposed modular solution allows to form an antenna 1, with individual conductive radial antenna elements stacked horizontally and separated from each other by about ½ of the wavelength of the RF signal. Only the antenna aperture elements, such as the filter slots 13 and the pin structures 8, 11 on front plate 12, need to have about ½ wavelength separation, not more than 0.8 of the wavelength of the RF signal.

A drum type radome can be used with embodiments of the present invention and can be made from COTS materials. Such a radome is much lower in cost than a cone type dedicated construction.

A conductive material such as a flat sheet of metal such as aluminium is used to make a tapered front plate 12 which is mechanically fixed to a plurality of front edges of a plurality of radial conductive guide plates to form the front plate 12. The front plate 12 needs to be tapered due to the different diameters D1 and D2. The method of making the mechanical fixing can include pins on the edges of the conductive radial antenna guide plates 7.

The front plate 12 is configured as a filter to match an air-interface transition from the air to the antenna 1. The front plate 12 can comprise resonant slots 13 forming a resonant filter plate 12. An RF signal arriving at the front plate 12 has a wavelength. The spacing between the resonant slots 13 is less than the half the wavelength of the RF signal.

The resonant slots 13 can be tuned as a function of frequency and allow for small band filtering to get rid of out-of-band frequencies.

### Cassettes

Antenna 1 preferably comprises one or more cassettes 20, each cassette 20 comprising a plurality of the conductive radial antenna elements 2.

The number of cassettes 20 in antenna 1 is selectable. Antenna 1 may comprise 16 to 128, preferably 32 to 64, cassettes 20. For example, the most used radar for ATC, which is S-band airport approach (ASR), needs 64 cassettes each containing 4 radiating antenna slots or 32 cassettes each containing 8 radiating antenna slots. The second most ATC is for long range enroute detection, L-band, and is likely optimal with 64 cassettes containing 4 radiating antenna slots or 32 cassettes containing 4 radiating antenna slots.

Using cassettes allows installation, maintenance and repair in an efficient and safe manner. A cassette 20 forms a module of a modular system and can be inserted or removed from the antenna. Each cassette 20 can be made of conductive sheet material and can comprise a base plate 9, a front plate 12 and a curved reflector plate 10. Antenna 1 has a substantially annular or ring-shaped or sector-shaped body which is formed by mounting a plurality of conductive cassettes 20 one adjacent to the next one around in a circle or in a sector of a circle. The cassettes 20 are removable from antenna 1. The use of removable cassettes allows easy and timesaving replacement or repair or construction. The use of cassettes provides the flexibility to adapt to the required antenna technical specification. It provides the possibility to easily re-arrange an antenna in a time-efficient way compared to existing antenna structures which would require a time-consuming complete re-design. The antenna can optionally be stationary in operation, e.g. non-rotating.

A full 360° antenna, i.e. a full-circle antenna 1 can be provided with less than, for example, twenty cassettes 20. FIG. 1a shows a full-circle antenna 1 comprising 64 cassettes 20. A patch antenna feed array(s) 14 is located at a bottom front inside (cfr. FIG. 4) of each cassette 20. The patch antenna feed 14 emits an RF signal reflected by the conductive curved reflector plate 10 to create a pattern such as a COSEC2 beam pattern. For example, two patch antenna feed arrays 14 can be located at a bottom front inside of each cassette 20, the two patch antenna feed arrays 14 each emitting an RF signal reflected by the conductive curved reflector plate 10. Cassettes 20 are placed against each other or with a very small separation distance between each other, such as less than 1/10th of the wavelength of the RF signal. The proposed modular solution allows to form an antenna 1, with individual conductive radial antenna elements 2 distributed vertically and separated from each other by about ½ of the wavelength of the RF signal.

Only the antenna aperture elements need to be separated from each other by ½ of the wavelength of the RF signal, preferable not more than 0.8 times this wavelength.

Optionally, in some cassettes 20 or in each cassette 20, each conductive radial guide plate 7 or several or most of the conductive radial guide plates 7 can be shared by two neighbouring antenna elements 2. Hence, in instead of two radial guide plates 20 per antenna element 7, there is only one. This arrangement reduces the weight by a factor of about 2. In case a cassette 20 contains more than two antenna elements 2, at least one radial guide plate 7 can be shared by neighbouring antenna elements 2. This also results in a reduction of the weight.

### Improved Construction Method

A construction method according to the present invention includes the subtractive machining of conductive sheet material using conventional machining methods such as stamping, cutting, grinding, milling, laser ablation and drilling.

An antenna according to embodiments of the present invention relates to a construction method therefor and an operation of the antenna as a phased array. The antenna according to embodiments of the present invention allows a simple construction for a sector-shaped antenna or full circle, i.e. circular, antenna. This allows easy and timesaving replacement of existing rotating parabolic or planar phased array antennas as used, for example, in air-traffic control radar systems, as well as of more compact antenna installations. The antenna and the method of construction according to the present invention are also advantageous for supporting high-speed mobile data communication because of its agile electronic beam pointing. The antenna can optionally be stationary in operation, e.g. non-rotating.

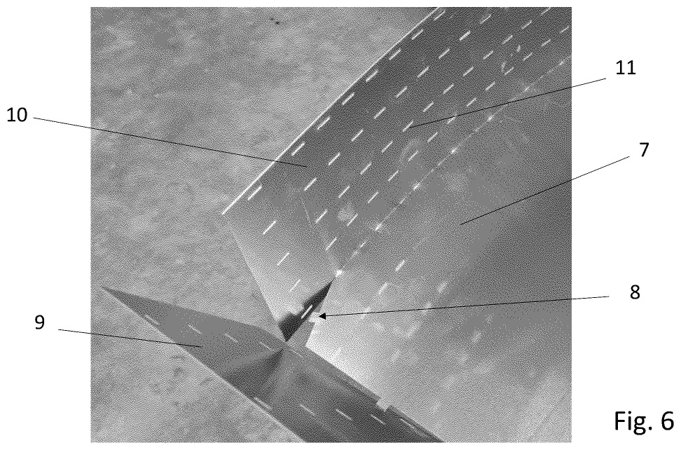

Embodiments of the present invention provide a method of constructing an antenna 1 from a plurality of plates 7, 9, 10, 12. Each plate can be made of a conductive sheet material, such as metal, for example aluminium, or of any conductive synthetic material. Each plate 7, 9, 10, 12 has two parallel faces and at least one edge. The at least one edge of one plate 7 comprises a connection means for mechanical, and optionally for electronic, connection to one of the two faces of at least one of the other plates 9, 10, 12. The connection means for mechanical, and optionally for electronic, connection for any, some or all plates 7, 9, 10, 12 is shape-locked. The connection means for mechanical, and optionally for electronic, connection comprises pins on the at least one edge of the one plate which are inserted into pinholes 11 located in at least one of the two faces of at least one of the other plates 9, 10, 12. The pins are subsequently bent over to lock the pins in the pinholes 11. Alternatively, the connection means for mechanical, and optionally for electronic, connection comprises on the at least one edge of the one plate 7 arrowheads which are inserted into pinholes or slots 11 located in at least one of the two faces of at least one of the other plates 9, 10, 12. The arrowheads are subsequently bent over or twisted to lock the arrowheads in the pinholes or slots 11. Alternatively, instead of pins or arrowheads, the connection means for mechanical, and optionally for electronic, connection comprises lips (e.g. rectangular, square or other shape) shape-locked in pinholes or slots 11 (shown in FIG. 6). The shaped-locked connection means for mechanical, and optionally for electronic, connection are preferably distributed evenly on at least one edge or face of the plates 7, 9, 10, 12.

The plurality of plates 7, 9, 10, 12 is selected from radial guide plates 7, front plates 12, bottom plates 9 and reflector plates 10.

Antenna 1 has a substantially annular or ring-shaped or sector-shaped form and has a flat base and inner and outer circular concentric boundaries. The antenna comprises an array of radially placed antenna elements 2 forming together a ring or part of a ring, i.e. a sector of a ring. Each antenna element 2 comprises at least two spaced apart non-parallel but rather radial conductive guide plates 7 and a reflector plate 10. The reflector plate 10 is configured to focus radio frequency energy in the form of an RF signal, e.g. RF beams, focussed at one or more elevations. Each radial conductive guide plate 7 can optionally be shared by adjacent antenna elements 2. Each antenna element 2 includes a front plate 12 configured as a resonant slot filter which is used to match an air-interface to the antenna elements 2 and the transition to the antenna 1 for the RF signal incident on the filter, the RF signal having a wavelength. Antenna 1 is bounded by an outer circle forming an outer boundary having a diameter D1 and bounded by an inner circle forming an inner boundary which at the bottom of antenna 1 has a diameter D2 The inner circle is concentric with the outer circle.

Each radial antenna element 2 is made with two or more radial conductive guide plates 7, each of the two or more radial conductive guide plates 7 having a curved edge, a front edge and a bottom edge.

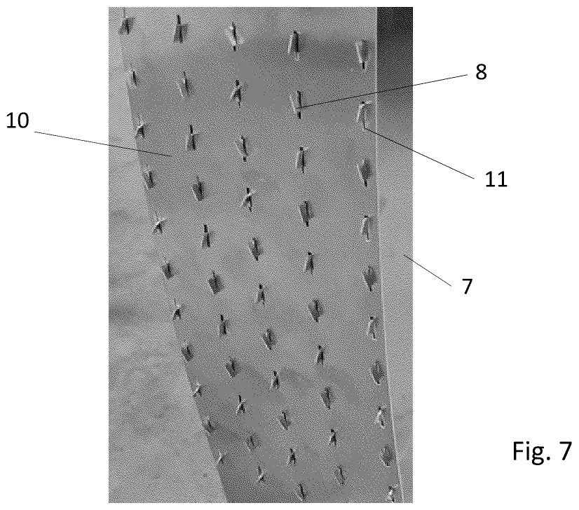

A first conductive sheet material, which will form the reflector plate 10 of antenna element 2, is fixed mechanically in a shape-locked way to, and optionally electronically connected to, the curved edge of the two or more radial antenna elements 2 to form a conductive curved reflector plate 10 as shown in FIG. 7.

One or more antenna feeds 14 can be offset from the conductive curved reflector plate 10 as shown in FIG. 4.

Thereafter, a second conductive sheet material is mechanically, optionally in a shape-locked way, fixed to, and optionally electronically connected to, the front edge of the two or more radial conductive guide plates 7 to form a front plate 12 of antenna element 2.

Neighbouring antenna elements 2 are located on one side of radial conductive guide plate 7 and a further neighbouring antenna element 2 on the other side of the radial conductive guide plate 7.

Front plate 12 is configured as a filter to match an air-interface transition to antenna 1.

Front plate 12 comprises resonant slots 11 and is configured to operate these slots 11 as a resonant front filter plate.

Furthermore, a third conductive sheet material is mechanically and in a shape-locked way fixed to, and optionally electronically connected to, the bottom edge of the two or more radial conductive guide plates 7 to form a bottom plate 10.

It is clear that the sequence of steps of fixing the first, second and third sheet material to the two or more radial conductive guide plates 7 may be carried out in any order. For example, the second sheet material could be fixed first, followed by the fixing of the first or third sheet material.

The step of mechanically fixing the respective edges of radial guide plate 7 in a shape-locked way to the front plate 12 and/or the bottom plate 9 and/or the reflector plate 10 can be as follows.

The at least one edge of the radial guide plate 7 comprises a connection means for mechanical, and optionally for electronic, connection to at least one of the other plates 9, 10, 12, i.e. the reflector plate 10, the front plate 12 and the bottom plate 9. The connection means for mechanical, and optionally for electronic, connection comprises pins 8 on the at least one edge of the radial guide plate 7 which pins are inserted into pinholes 11 located in at least one of the other plates 9, 10, 12, i.e. the reflector plate 10, the front plate 12 and the bottom plate 9. The pins 8 are subsequently bent over to lock the pins 8 in the pinholes 11.

Alternatively, the connection means for mechanical, and optionally for electronic, connection comprises on the at least one edge of the radial guide plate 7 arrowheads 8 which are inserted into pinholes or slots 11 located in at least one of the other plates 9, 10, 12, i.e. the reflector plate 10, the front plate 12 and the bottom plate 9. The arrowheads 8 are subsequently bent over or twisted to lock the arrowheads 8 in the pinholes or slots 11.

Alternatively, the connection means for mechanical, and optionally for electronic, connection comprises lips 8 (e.g. rectangular, square or other shape) (shown in FIG. 6) on the at least one edge of the radial guide plate 7, which lips 8 are inserted into slots 11 located in at least one of the other plates 9, 10, 12, i.e. the reflector plate 10, the front plate 12 and the bottom plate 9. The lips 8 are subsequently bent over or twisted to lock the lips 8 in the slots 11.

A further alternative included in the present invention is to insert the pins 8 of the respective edges of the radial guide plate 7 in the pinholes 11 of the front plate 12 and/or the bottom plate 9 and/or the reflector plate 10 and to subsequently bend the pins 8 to lock them in the pinholes 11. The same reasoning applies when arrowheads 8 are used or when lips 8 (e.g. rectangular, square or other shape) are used.

Each radial antenna element 2 is placed with its bottom plate 9 on a radius of the outer circle with diameter D1, so that the curved reflector plate 10 is positioned inwardly and the front plate 12 is positioned outwardly. This way reflector plate 10 is facing the inner circle and front plate 12 is facing the outer circle.

The method can also include a step of placing a plurality (i.e. two or more) of radial antenna elements 2 together in a cassette 20. A cassette is two or more radial antenna elements 2 in a module, which module can be inserted or removed from antenna 1, e.g. for repair or replacement or construction on site. The cassettes 20 are removable from antenna 1. The use of removable cassettes allows easy and timesaving replacement or repair or construction. Optionally, in each cassette 20, each conductive radial guide plate 7 or several or most of the conductive radial guide plates 7 can be shared by two neighbouring antenna elements 2. Hence, in instead of two radial guide plates 7 per antenna element 2, there is only one. This arrangement reduces the weight by a factor of about 2. In case a cassette 20 contains more than two antenna elements 2, at least one radial guide plate 7 can be shared by neighbouring antenna elements 2. This also results in a reduction of the weight.

Additionally, the method places an antenna feed 14, comprising for example a patch antenna feed array 14 at a bottom front inside of each cassette, i.e. on bottom plate 9 and adjacent front plate 12. Patch antenna feed array 14 is configured for emitting an RF signal to the conductive curved reflector plate 10 which is configured to reflect the signal, so that the signal will exit antenna 1. Alternatively, antenna 1 is configured to receive an RF signal which is reflected by conductive curved reflector plate 10 to patch antenna feed array 14.

Additionally or alternatively, the method places an antenna feed 14, comprising for example two or more patch antenna feed arrays 14 at a bottom front inside of each cassette, i.e. on bottom plate 9 and adjacent front plate 12. The two or more patch antenna feed arrays 14 are configured for emitting RF signals to the curved reflector plate which reflects the signals, so that each exit antenna 1 at a different elevation angle. Alternatively, antenna 1 is configured to receive RF signals from different elevation angles which are reflected by conductive curved reflector plate 10 to the two or more patch antenna feed arrays 14.

The RF signal has a wavelength and a spacing is set between the resonant slots in front plate 12 that is less than half of the wavelength of the RF signal.

The resonant slots are tuned as a function of frequency and allow for small band filtering to get rid of out-of-band frequencies.

The patch antenna feed arrays 14 are adapted to emit the RF signal which is reflected by conductive curved reflector 10, creating a COSEC2 beam pattern.

Transmit Receive electronics are located at the bottom back inside each cassette, i.e. on bottom plate 9 and adjacent reflector plate 10.

The Transmit Receive electronics are joined to the patch antenna feed array 14 with low-loss transmission lines.

Antenna 1 is configured for use as a phased array.

A switching matrix is configured to control two user applications accessing the same antenna.

Antenna 1 constructed by the methods of the present invention preferably has a substantially annular or ring-shaped or sector-shaped body with inner and outer multifaceted circular boundaries wherein these inner and outer circular boundaries are concentric with each other. Antenna 1 has a flat base. Antenna 1 has a form approximating a surface of revolution of half-a-parabola-like shape, whereby antenna 1 has a hole in the middle. The axis of revolution passes through centre of the hole and does not intersect with the multifaceted surfaces of antenna 1. This shape is achieved by a plurality of radially placed conductive antenna elements 2 each being a part of a sector of a hemisphere, whereby these antenna elements 2 are placed next to each other around a circle or sector of a circle. When placed together, the antenna elements 2 each comprise two or more spaced apart radial conductive guide plates 7. The shape of half a parabola corresponds to the shape of a radial guide plate 7 which is part of antenna element 2. This shape is the shape of a cross-section taken vertically through antenna element 2 and, hence, through antenna 1.

The radial antenna elements 2 also form reflectors to focus radio frequency energy incident on these reflectors in the form of an RF signal, e.g. one or more RF beams focussed at one or more elevations. Each radial conductive guide plate 7 can be shared by adjacent antenna elements 2. Antenna 1 includes a front plate 12 configured as a filter which is used to match an air-interface transition to the antenna for the RF signal incident on the filter, the RF signal having a wavelength. The antenna elements 2 contributing to the antenna aperture need to be separated from each other by about ½ of the wavelength of the RF signal or less and not more than 0.8 times this wavelength.

Cassette 20 constructed from antenna elements 2 constructed from the sheet pieces shown in FIG. 3 helps to lower the complexity of the structure and, hence, of the construction method. The design of cassette 20 reduces horizontal wiring by a factor of four or more. FIG. 4 shows a conductive radial guide plate 7 that is shown as a section through an antenna element or through a cassette, with a mechanical fixing means such as pins or arrowheads or lips 8 on the curved edge of the conductive radial guide plate 7 as well as the reflector plate 10 shaped to form, for example, a COSEC2 pattern. Front plate 12 is designed as a filter. Reference 15 indicates inputs for the electronics such as dual feed line inputs to antenna 1 and TRM electronics.

The cost of existing large flat antenna arrays is further increased by logistic problems on weight and delicate transport, as they need to be built as one piece in a factory and transported over large distances. The new modular setup of an antenna 1 according to embodiments of the present invention is designed to be transported with standard shipping containers and allows simplified assembly and maintenance on site requiring less specialist knowledge.

This is achieved by the plates 7, 9, 10, 12 being shipped and transported in kit form such as a combination of front plate 12, bottom plate 9, reflector plate 10 and the conductive radial guide plates 7. Parts of the cassettes 20 including a curved radial plate reflector comprising a curved reflector plate 10 fixed to curved edges of radial conductive guide plates 7 can be connected to each other and then shipped. The cassettes 20 can also include fixing front and bottom plates 12 and 9 to the front and bottom edges of radial conductive guide plates 7.

Accordingly, flat and thin metal sheet material such as aluminium sheet in a thickness between 0.5 and 1 mm or thicker, such as 1 to 5 mm or 1 to 10 mm can be used for conductive radial guide plates 7, bottom plates 9, and reflector plates 10 as shown in the Figures. The antenna 1 is self-supporting with minimal or no use of screws, rivets or welding. A minimalistic support construction 5 (cfr. FIG. 1b) is used to foresee an antenna floor 3 which can be used as a maintenance floor and to mount the complete antenna 1 on a tower or around a mast using the mast-drive-through hole 6.

The use of only flat sheet material allows the antenna components to be specified in a CAD file for direct laser cutting as available in standard metal workshops. The cassette construction method can use half (compared to, for example, the antenna of U.S. Pat. No. 4,051,476) the number of guide-plates resulting in a reduction of cost, weight and size.

The assembly of the plates 7, 9, 10, 12 using pinhole connections 11 and pins 8, such as an arrowheads and slots can be fixed with a simple twist or bending. This method is fast and still strong enough to be self-supporting and to make electrical connection. It dramatically reduces assembly cost. Reflector plate 10 and bottom plate 9 are connected, using this method, to the conductive radial guide-plates 7.

For example, pins 8 formed on the edges of a plate can have an arrowhead shape and can be inserted into pinholes 11 or slots of another plate, be it another radial conductive guide plate 7 or the bottom plate 9 or the front plate 12 or the reflector plate 10 of cassette 20. Pins 8 or arrowheads 8 can then twisted be twisted or bent over with the result that each pin 8 or arrowhead 8 is locked in the pinhole or slot 11 of the plate. To be able to lock the pin 8 or the arrowhead 8 in a pinhole 11 of the pinhole connection or in a slot 11 allows to construct a robust antenna 1. Instead of or in combination with pins or arrowheads, lips can be used as described above.

FIG. 6 shows a detail of assembling an antenna element 2 or cassette 20. Each antenna element 2 has a number of radial guide-plates 7, such as for example two or more. Cassette 20 has a number of radial guide-plates 7, such as, for example two or more, e.g. four or five (as shown). Reflector plate 10 takes its specific shape thanks to the solid mechanical connections 8, 11. The slots 11 where the other guide plates 7 are connected can be seen in the reflector plate 10.

FIG. 6 shows, in reflector plate 10, five rows of mechanical connections 8, 11 which attach the curved edges of five conductive radial guide plates 7 to reflector plate 10 and the bottom plate 9. Lips 8 are inserted into pinholes or slots 11 and bent or twisted to lock them in place. Instead of lips 8 or arrowheads 8 in slots 11, pins 8 in pinholes 11 can be used.

When bottom plate 9, reflector plate 10 and front plate 12 are connected together, this forms an antenna element 2 in a cassette 20.

FIG. 7 shows a reflector plate 10 comprising five rows of slots 11 in which lips 8 or arrowheads 8 of a radial guide plate 7 have been placed and shape-locked by bending or twisting. Here too, instead of lips 8 or arrowheads 8 in slots 11, pins 8 in pinholes 11 can be used.

Further aspects of the present invention are:

1. An antenna bounded by an outer circle forming an outer boundary having a diameter D1 and bounded by an inner circle forming an inner boundary having a diameter D2, the inner circle being concentric with the outer circle, the antenna comprising:
a plurality of radial antenna elements, each radial antenna element comprising two or more radial conductive guide plates, each of the two or more radial conductive guide plates having a curved edge, a front edge and a bottom edge; wherein each radial antenna element and each radial guide plate lies on a radius of said outer circle,
a first conductive sheet material which is mechanically fixed to, and optionally electronically connected to, a plurality of the curved edges of the plurality of radial antenna elements to form a conductive curved reflector,
one or more antenna feeds, the one or more antenna feeds being offset from the conductive curved reflector,
each radial conductive guide plate being shared between a neighbouring antenna element on one side of the radial conductive guide plate and a further neighbouring antenna element on the other side of the radial conductive guide plate.

2. An antenna according to aspect 1, wherein a range of the ratio of D2 over D1 is in the range of 0.8 to 0.3 or in the range of 0.7 to 0.5.

3. An antenna according to aspect 1 or 2, wherein a second conductive sheet material is mechanically fixed to, and optionally electronically connected to, a plurality of front edges of a plurality of radial conductive guide plates to form a front plate.

4. An antenna according to aspect 3, wherein the front plate is configured as a filter to match an air-interface transition to the antenna.

5. An antenna according to aspect 4, wherein the front plate comprises resonant slots forming a resonant front filter plate.

6. An antenna according to any of the aspects 1 to 5, wherein a third conductive sheet material is mechanically fixed to, and optionally electronically connected to, a plurality of bottom edges of a plurality of radial conductive guide plates to form a bottom plate.

7. An antenna according to any of the previous aspect, wherein each conductive sheet material has faces and two or more radial conductive guide plates have a plurality of edges, one or more of the plurality of edges having a means for mechanical connection, optionally in a shape-locked way, and optionally for electronic connection, to the faces.

8. An antenna according to aspect 7, wherein the means for mechanical connection in a shape-locked way, and optionally for electronic connection, comprises pin structures on one or more of the plurality of edges in the form of pins, arrowheads or lips which are inserted into pinholes or slots in the faces, wherein the pins are bent over in a shape-locked way to lock the pins into the pinholes, the arrowheads being bent over or twisted to shape-lock the arrowheads into the pinholes or slots or the lips being bent over to shape-lock the lips into the pinholes or slots.

9. An antenna according to any of the preceding aspects, further comprising one or more cassettes, each cassette comprising the one or more of the radial antenna elements.

10. An antenna according to aspect 9, wherein each cassette is removable from the antenna for maintenance, repair or replacement.

11. An antenna according to aspect 9 or 10, wherein each cassette has a reflector plate, a bottom plate and optionally a front plate.

12. An antenna according to any of the aspects 9 to 11, wherein a patch antenna feed array is located at a bottom front inside of each cassette, the patch antenna feed array emitting an RF signal reflected by the conductive curved reflector.

13. An antenna according to aspect 12, comprising two patch antenna feed arrays located at a bottom front inside of each cassette, the two patch antenna feed arrays emitting an RF signal reflected by the conductive curved reflector towards a front plate providing beams at at least two elevations.

14. An antenna according to aspect 12 or 13, wherein the RF signal has a wavelength and a spacing between the resonant slots in the front plate is less than half of the wavelength of the RF signal.

15. An antenna according to aspect 14, wherein the resonant slots are tuned as a function of frequency and allow for small band filtering to get rid of out of band frequencies.

16. An antenna according to any of the aspects 12 to 15, wherein the patch antenna feed arrays emitting the RF signal reflected by the conductive curved reflector, creates a COSEC2 beam pattern.

17. An antenna according to any of the aspects 9 to 16, wherein Transmit Receive electronics are located at the bottom back inside of each cassette.

18. An antenna according to any of the aspects 9 to 17, wherein the Transmit Receive electronics is located on a PCB and one or two patch antenna feed arrays are located on the same PCB as the TRM electronics.

19. An antenna according to aspect 18, wherein the Transmit Receive electronics are joined to the patch antenna feed array with low-loss transmission lines.

20. An antenna according to any of the preceding aspects, comprising a switching matrix configured to control two user applications accessing the same antenna.

21. An antenna according to any of the preceding aspects, wherein the antenna is configured for use as a phased array.

22. An antenna according to any of the preceding aspects, wherein the antenna is a sector or full 360° antenna.

23. An antenna according to any of the preceding aspects, wherein the antenna is a ring-shaped or sector-shaped or toroid-shaped antenna and/or stationary in operation, and/or non-rotating.

24. An antenna according to any of the preceding aspects, wherein the first, second or third conductive sheet material is a metal sheet.

25. An antenna according to any of the aspects 21 to 24, wherein a plurality of radial antenna elements of the antenna is configured for operation as the phased array.

26. An antenna according to any of the aspects 21 to 25, wherein a plurality of radial antenna elements of the antenna is configured for operation as an electronically scanned array.

27. An antenna according to any of the previous aspects, wherein a beam of radio frequency waves is electronically steered by the antenna to point in different directions without moving the antenna.

28. An antenna according to any of the previous aspects, wherein Radio frequency current from a transmitter is fed to the multiple individual antenna elements with a phase relationship so that the radio waves from the separate antenna elements are configured to combine to form beams, to increase power radiated in desired directions and suppress radiation in undesired directions.

29. An antenna according to any of the aspects 21 to 28, wherein the antenna is configured to operate as a phased array and comprises phase shifters and a transmitter configured to feed power from the transmitter to radiate through the front antenna elements through the phase shifters, the antenna is configured to control the phase shifters and the phase shifters are configured to alter the phase or signal delay electronically, thus steering the beam of radio waves to different directions.

30. An antenna according to any of the aspects 21 to 29, further comprising the antenna being adapted to scan in azimuth by feeding RF power into Transmit/Receive (T/R) modules.

31. A method of constructing an antenna from a plurality of plates, wherein the antenna is bounded by an outer circle forming an outer boundary having a diameter D1 and bounded by an inner circle forming an inner boundary having a diameter D2, the inner circle being concentric with the outer circle, and wherein the plurality of plates being selected from front plates, bottom plates, guide plates and reflector plates of the antenna, each guide plate having an edge, and the front, bottom and reflector plates have a face, wherein an edge of each guide plate is machined to form a shape-locked mechanical, and optionally electronic, connection with faces of the front, bottom and reflector plates.

32. A method according to aspect 31, wherein pin structures are machined on an edge of the guide plates and pin receiving structures are machined on the faces for receiving the pin structures to form the shape-locked mechanical, and optionally electronic, connection.

33. A method according to aspect 32, wherein the pin receiving structure are formed as pinholes or slots and wherein the pin structures are formed as pins, arrowheads or lips which are inserted into pinholes or slots in the at least one face, the pins being bent over to shape-lock the pins into the pinholes, the arrowheads being bent over or twisted to shape-lock the arrowheads into the slots or pinholes or the lips being bent over to shape-lock the lips into the slots or pinholes.

34. The method of aspect 31 or 33, wherein a range of the ratio of D2 over D1 is in the range of 0.8 to 0.3 or in the range of 0.7 to 0.5.

35. The method according to any of the aspects 31 to 34, comprising the step of making a plurality of radial antenna elements, each radial antenna element being made with two or more radial conductive guide plates, each of the two or more radial conductive guide plates having a curved edge, a front edge and a bottom edge; wherein each radial antenna element and each radial guide plate is placed on a radius of the outer circle with diameter D1.

36. The method according to any of the aspect 31 to 35, further comprising the step of fixing first conductive sheet material mechanically, optionally in a shape-locked way to, and optionally of electronically connecting to, a plurality of the curved edges of a plurality of radial antenna elements to form a conductive curved reflector.

37. The method according to aspect 36 further comprising the step of offsetting one or more antenna feeds from the conductive curved reflector.

38. The method according to any of the aspects 31 to 37, each radial conductive guide plate is adapted to be shared between a neighbouring antenna element on one side of the radial conductive guide plate and a further neighbouring antenna element on the other side of the radial conductive guide plate.

39. The method according to any of the aspects 36 to 38, wherein a second conductive sheet material is mechanically fixed, optionally in a shape-locked way, to and optionally electronically connected to, a plurality of front edges of a plurality of radial conductive guide plates to form a front plate.

40. The method according to aspect 39, wherein the front plate is configured as a filter to match an air-interface transition to the antenna.

41. The method according to aspect 39 or 40, wherein the front plate is configured with resonant slots so that the front plate operates as a resonant front filter plate.

42. The method according to any of aspects 31 to 41, wherein a third conductive sheet material is mechanically fixed, optionally in a shape-locked way to, and optionally electronically connected to, a plurality of bottom edges of a plurality of radial conductive guide plates to form a bottom plate.

43. The method according to any of the aspects 31 to 42, further forming one or more cassettes, each cassette comprising a plurality of the radial antenna elements.

44. The method according to aspect 43, comprising locating a patch antenna feed array at a bottom front inside of each cassette, the patch antenna feed array being adapted to emit an RF signal to be reflected by the conductive curved reflector.

45. The method according to aspect 44, comprising the step of locating two patch antenna feed arrays at a bottom front inside of each cassette, the two patch antenna feed arrays being configured to emit an RF signal reflected by the conductive curved reflector towards a front plate providing beams at at least two elevations.

46. The method according to aspect 44 or 45, wherein the RF signal has a wavelength and a spacing is set between the resonant slots that is less than half of the wavelength of the RF signal.

47. The method according to aspect 46, wherein the resonant slots are tuned as a function of frequency and are constructed for small band filtering to get rid of out of band frequencies.

48. The method according to any of the aspects 45 to 47, wherein the patch antenna feed arrays are arranged to emit the RF signal which is reflected by the conductive curved reflector, creating a COSEC2 beam pattern.

49. The method according to any of the aspects 43 to 48, wherein Transmit Receive electronics are located at the bottom back inside each cassette.

50. The method according to aspect 49, further comprising the step of joining the Transmit Receive electronics to the patch antenna feed array with low-loss transmission lines.

51. The method according to any of the aspects 31 to 50, further comprising configuring the antenna for use as a phased array.

52. The method according to any of the aspects 31 to 51, comprising configuring a switching matrix to control two user applications accessing the same antenna.

53. The method according to any of the aspects 42 to 52, wherein the first, second or third conductive sheet material is a metal sheet.

54. The method according to any of the aspects 31 to 53, wherein the antenna is a or ring-shaped sector-shaped or toroid-shaped antenna and/or stationary in operation and/or non-rotating.

55. A method of operating an antenna comprising the step of: operating a plurality of radial antenna elements of the antenna as a phased array or an electronically scanned array.

56. The method according to aspect 55, wherein the antenna is an antenna as defined in any of the aspects 1 to 30.

57. The method according to aspect 55 or 56, wherein a beam of radio frequency waves is electronically steered by the antenna to point in different directions without moving the antenna.

58. The method according to any of the aspects 55 to 57, wherein Radio frequency current from a transmitter is fed to the multiple individual antenna elements with a phase relationship so that the radio waves from the separate antenna elements are configured to combine to form beams, to increase power radiated in desired directions and suppress radiation in undesired directions.

59. The method according to any of the aspects 55 to 58, wherein the antenna is operated as a phased array, the power from a transmitter being fed to radiate through the front antenna elements via phase shifters, which are controlled by a controller and which can alter the phase or signal delay electronically, thus steering the beam of radio waves to different directions, e.g. one, two or more elevations.

60. The method according to any of the aspects 55 to 59, further comprising the antenna scanning in azimuth by feeding the relevant RF power into Transmit/Receive (T/R) modules.

61. Use of an antenna of any of the aspects 1 to 30, as a phased array.

62. Use of an antenna constructed in accordance with a method of any of the aspects 31 to 53, as a phased array.

63. Antenna element comprising two or more radial conductive guide plates, each of the two or more radial conductive guide plates having a curved edge, a front edge and a bottom edge.

64. Antenna cassette comprising one or more of the radial antenna elements defined in aspect 63, wherein the cassette has two or more conductive radial guide plates, a reflector plate, a bottom plate and optionally a front plate.

65. Antenna cassette according to aspect 64, wherein a patch antenna feed array is located at a bottom front inside of the cassette, the patch antenna feed array emitting an RF signal reflected by the reflector plate.

66. Antenna cassette according to aspect 64 or 65, comprising two patch antenna feed arrays located at a bottom front inside of the cassette, the two patch antenna feed arrays emitting an RF signal reflected by the reflector plate towards the front plate providing beams at at least two elevations.

67. Antenna cassette according to any of the aspects 64 to 66, wherein the two or more radial guide plates have a plurality of edges, one or more the plurality of edges having a means for mechanical, optionally in a shape-locked way, connection and optionally for electronic connection, to the faces.

68. Antenna cassette according to aspect 67, wherein the means for mechanical connection, optionally in a shape-locked way, and optionally for electronic connection, comprises pin structures on one or more of the plurality of edges in the form of pins, arrowheads or lips inserted into pinholes or slots in the faces, the pins being bent over to be fixed in a shape-locked way into the pinholes, the arrowheads being bent over or twisted to shape-lock the arrowheads into the slots or pinholes or the lips being bent over to shape-lock the lips into the slots or pinholes.

1. An antenna bounded by an outer circle forming an outer boundary having a diameter D1 and bounded by an inner circle forming an inner boundary having a diameter D2, the inner circle being concentric with the outer circle, the antenna comprising:
a plurality of radial antenna elements, each radial antenna element comprising two or more radial conductive guide plates, each of the two or more radial conductive guide plates having a curved edge, a front edge and a bottom edge; wherein each radial antenna element and each radial guide plate lies on a radius of said outer circle,
a first conductive sheet material which is mechanically fixed to, and optionally electronically connected to the respective curved edges of the two or more radial conductive guide plates plurality of to form a conductive curved reflector,
one or more antenna feeds, the one or more antenna feeds being offset from the conductive curved reflector,
each radial conductive guide plate or several or most radial conductive guide plates is/are being shared between a neighbouring antenna element on one side of the radial conductive guide plate and a further neighbouring antenna element on the other side of the radial conductive guide plate.

2. The antenna according to claim 1, wherein a range of the ratio of D2 over D1 is in the range of 0.8 to 0.3 or in the range of 0.7 to 0.5.

3. The antenna according to claim 1, wherein a second conductive sheet material is mechanically fixed to, and optionally electronically connected to, the respective front edges of each of two or more radial conductive guide plates to form a front plate.

4. The antenna according to claim 1, wherein a third conductive sheet material is mechanically fixed to, and optionally electronically connected to, a plurality of bottom edges of a plurality of radial conductive guide plates to form a bottom plate.

5. The antenna according to claim 1, wherein each conductive sheet material has faces and two or more radial conductive guide plates have a plurality of edges, one or more of the plurality of edges having a means for mechanical connection, optionally in a shape-locked way, and optionally for electronic connection, to the faces, and wherein the means for mechanical connection in a shape-locked way, and optionally for electronic connection, comprises pin structures on one or more of the plurality of edges in the form of pins, arrowheads or lips which are inserted into pinholes or slots in the faces, wherein the pins are bent over in a shape-locked way to lock the pins into the pinholes, the arrowheads being bent over or twisted to shape-lock the arrowheads into the pinholes or slots or the lips being bent over to shape-lock the lips into the pinholes or slots.

6. The antenna according to claim 1, further comprising one or more cassettes, each cassette comprising the one or more of the radial antenna elements and wherein each cassette is removable from the antenna for maintenance, repair or replacement.

7. The antenna according to claim 6, wherein a patch antenna feed array is located at a bottom front inside of each cassette, the patch antenna feed array emitting an RF signal reflected by the conductive curved reflector.

8. The antenna according to claim 7, comprising two patch antenna feed arrays located at a bottom front inside of each cassette, and wherein the two patch antenna feed arrays are configured to emit an RF signal reflected by the conductive curved reflector towards a front plate providing beams at at least two elevations along elevation axes of the antenna.

9. The antenna according to claim 7, wherein the patch antenna feed arrays emitting the RF signal reflected by the conductive curved reflector, creates a COSEC2 beam pattern.

10. The antenna according to claim 6, wherein transmit receive electronics are located at the bottom back inside of each cassette.

11. The antenna according to claim 10, wherein the transmit receive electronics of the antenna are located on a PCB and one or two patch antenna feed arrays are located on the same PCB as the TRM electronics.

12. The antenna according to claim 1, wherein the antenna is selected from: a sector or full 360° antenna, a ring-shaped antenna, a sector-shaped antenna, a toroid-shaped antenna, a stationary in operation antenna, or a non-rotating antenna.

13. The antenna according to claim 1, wherein the antenna is configured such that a beam of radio frequency waves is electronically steered by the antenna to point in different directions without moving the antenna.

14. The antenna according to claim 12, wherein the antenna is configured to operate as a phased array and comprises phase shifters and a transmitter configured to feed power from the transmitter to radiate through the front antenna elements through the phase shifters, the antenna is configured to control the phase shifters and the phase shifters are configured to alter the phase or signal delay electronically, thus steering the beam of radio waves to different directions.

15. The antenna according to claim 12, further comprising the antenna being adapted to scan in azimuth by feeding RF power into transmit/receive (T/R) modules.

16. A method of constructing an antenna from a plurality of radial antenna elements, each radial antenna element comprising two or more radial conductive guide plates, wherein the antenna is bounded by an outer circle forming an outer boundary having a diameter D1 and bounded by an inner circle forming an inner boundary having a diameter D2, the inner circle being concentric with the outer circle, the antenna further comprising front plates, bottom plates, guide plates and curved reflector plates, wherein each radial conductive guide plate has a curved edge, a front edge, and a bottom edge, wherein the front plates, bottom plates and curved reflector plates have a face, wherein an curved edge, the front edge and the bottom edge of each radial conductive guide plate is a machined edge and each radial conductive guide plate lies on a radius of said outer circle to form a shape-locked mechanical, and optionally electronic, connection with faces of the front, bottom and reflector plates.

17. The method according to claim 16, wherein pin structures are machined on an edge of the guide plates and pin receiving structures are machined on the faces for receiving the pin structures to form the shape-locked mechanical, and optionally electronic, connection.

18. The method according to claim 17, wherein the pin receiving structure are formed as pinholes or slots and wherein the pin structures are formed as pins, arrowheads or lips which are inserted into pinholes or slots in the at least one face, the pins being bent over to shape-lock the pins into the pinholes, the arrowheads being bent over or twisted to shape-lock the arrowheads into the slots or pinholes or the lips being bent over to shape-lock the lips into the slots or pinholes.

19. The method of claim 16, wherein a range of the ratio of D2 over D1 is in the range of 0.8 to 0.3 or in the range of 0.7 to 0.5.

20. The method according to claim 16, comprising the step of: making a plurality of radial antenna elements, each radial antenna element being made with two or more radial conductive guide plates, each of the two or more radial conductive guide plates having a curved edge, a front edge and a bottom edge; wherein each radial antenna element and each radial guide plate is placed on a radius of the outer circle with diameter D1.

21. The method according to claim 16, further comprising the step of fixing first conductive sheet material mechanically, optionally in a shape-locked way to, and optionally of electronically connecting to, a plurality of the curved edges of a plurality of radial antenna elements to form a conductive curved reflector.

22. The method according to claim 16, wherein each radial conductive guide plate is adapted to be shared between a neighbouring antenna element on one side of the radial conductive guide plate and a further neighbouring antenna element on the other side of the radial conductive guide plate.

23. The method according to claim 21, wherein a second conductive sheet material is mechanically fixed, optionally in a shape-locked way, to and optionally electronically connected to, a plurality of front edges of a plurality of radial conductive guide plates to form a front plate.

24. The method according to claim 16, wherein a third conductive sheet material is mechanically fixed, optionally in a shape-locked way to, and optionally electronically connected to, a plurality of bottom edges of a plurality of radial conductive guide plates to form a bottom plate.

25. The method according to claim 16, further forming one or more cassettes, each cassette comprising a plurality of the radial antenna elements.

26. The method according to claim 25, comprising locating a patch antenna feed array at a bottom front inside of each cassette, the patch antenna feed array being adapted to emit an RF signal to be reflected by the conductive curved reflector.

27. The method according to claim 25, comprising locating a patch antenna feed array at a bottom front inside of each cassette, wherein the patch antenna feed arrays are arranged to emit the RF signal which is reflected by the conductive curved reflector, creating a COSEC2 beam pattern.

28. The method according to claim 16, comprising configuring a switching matrix to control two user applications accessing the same antenna.

29. The method according to claim 16, wherein the antenna is selected from: a sector or full 360° antenna, a ring-shaped antenna, a sector-shaped antenna, a toroid-shaped antenna, a stationary in operation antenna, or a non-rotating antenna.

30. The method according to claim 16, wherein a beam of radio frequency waves is electronically steered by the antenna to point in different directions without moving the antenna.

31. The method according to claim 16, wherein radio frequency current from a transmitter is fed to the plurality of radial antenna elements with a phase relationship so that the radio waves from separate radial antenna elements are configured to combine to form beams, to increase power radiated in desired directions and suppress radiation in undesired directions.

32. An antenna element comprising:
two or more radial conductive guide plates,
each of the two or more radial conductive guide plates having a curved edge, a front edge and a bottom edge.

33. An antenna cassette comprising:
one or more of the radial antenna elements comprising two or more radial conductive guide plates, each of the two or more radial conductive guide plates having a curved edge, a front edge and a bottom edge,
wherein the cassette has two or more conductive radial guide plates, a reflector plate, a bottom plate and optionally a front plate.

34. The antenna cassette according to claim 33, wherein the means for mechanical connection, optionally in a shape-locked way, and optionally for electronic connection, comprises pin structures on one or more of the plurality of edges in the form of pins, arrowheads or lips inserted into pinholes or slots in the faces, the pins being bent over to be fixed in a shape-locked way into the pinholes, the arrowheads being bent over or twisted to shape-lock the arrowheads into the slots or pinholes or the lips being bent over to shape-lock the lips into the slots or pinholes.
